(19) United States
(12) Patent Application Publication
(10) Pub. No.: US 2008/0155183 A1
(43) Pub. Date: Jun. 26, 2008

(54) Method of managing a large array of non-volatile memories

(76) Inventors: Zhiqing Zhuang, Irvine, CA (US); Ming Huang, Oak Park, CA (US)

Correspondence Address: Zhiqing Zhuang, 35 Mount Vernon, Irvine, CA, 92620, US

(21) Appl. No.: 11/953,859

(22) Filed: Dec. 11, 2007

Related U.S. Application Data
(60) Provisional application No. 60/875,328, filed on Dec. 18, 2006.

(51) Int. Cl. G06F 12/00

(52) U.S. Cl. 711/103; 711/E12.001

(57) ABSTRACT

The present invention provides a non-volatile flash memory management system and method that provides the ability to efficiently manage a large array of flash devices and allocate flash memory use in a way that improves reliability and longevity, while maintaining excellent performance. The invention mainly comprises of a processor, an array of flash memories that are modularly organized, an array of module flash controllers and DRAM caching. The processor manages the above mention large array of flash devices with caching memory through mainly two tables: Virtual Zone Table and Physical Zone Table, a number of queues: Cache Line Queue, Evict Queue, Erase Queue, Free Block Queue, and a number of lists: Spare Block List and Bad Block List.

### CROSS REFERENCE TO RELATED APPLICATIONS

This application claims priority to U.S. Provisional Application No. 60/875,328, filed on Dec. 18, 2006 which is incorporated in its entirety by reference herein.

### BACKGROUND OF THE INVENTION

1. Field of the Invention

This invention relates to the non-volatile memory storage system, and more particularly to managing a large array of non-volatile memory devices with caching, wear-leveling, physical block mapping and bad block management.

2. Description of Related Art

Recently, non-volatile solid state memory such as flash memory has gained popularity for use in replacing mass storage units in various technology areas such as computers, digital cameras, modems and the like. In such applications, usually only one or a small amount of flash devices are needed.

Solid state drives (SSDs) are devices that use exclusively non-volatile flash memory to store digital data. The two primary advantages resulting from using flash memory components instead of mechanical devices to store data are higher ruggedness and significantly improved performance in terms of random access speed, power consumption, and extended operating temperature range. They are typically used in the mission critical and high mechanically stressed environments such as enterprise, medical, aerospace and military.

However, the capacity of a single flash device (about a few Gbytes) is still far less than the capacity offered by a mechanical based hard drive (a few hundreds Gbytes). Thus a SSD must be built from a large array of flash devices in order for it to be useful as a replacement of mechanical drive in the mission critical and high mechanically stressed environments.

Though the flash device (throughput around 10 Mbytes per second) is already much faster than mechanical drive, it is still far from sustaining a storage interface such as fiber channel (200/400 Mbytes per second), serial ATA (150/300 Mbytes per second), or serial attached SCSI (300/600 Mbytes per second). Besides the speed limitation the flash read and write across the flash interface (around 25 MByte per second), there are also limitation with flash architecture. An inherent characteristic of flash memory is that they must be erased and verified for successful erase prior to being programmed. Write and erase cycles are generally slow and can significantly reduce the performance of a system.

Flash memory is organized as a number of pages, where a page is a flash read/write unit, and a number of blocks, where a block is an erase unit. The write and erase of flash block is limited to a finite number of erase-write cycles, which basically determines the lifetime of the device. A flash management system usually implements wear-leveling technique that spreads the write across entire flash memory blocks so the flash memory's lifespan is maximized by avoiding the excessive erases/writes to a small portion of entire available spaces.

Flash memory may have blocks permanently damaged and can not be used to store data after manufacture. And some blocks may turn to bad during the life time of flash device. So bad block management is required in a flash management system.

There is therefore a need within solid state drive to efficiently manage a large array of flash devices to provide increased system performance, improved reliability and longevity.

A flash management system using a unified re-map table in a RAM is taught by Bruce, et al. in U.S. Pat. No. 6,000,006, assigned to BIT Microsystems, Inc. of Fremont, Calif. Bruce, et al. uses a unified re-map table that can arbitrarily re-map all logical addresses from a host system to physical addresses of flash-memory devices. Each entry in the unified re-map table contains a physical block address (PBA) of the flash memory allocated to the logical address, and a cache valid bit and a cache index. This approach is adequate in managing a small amount of flash devices since it manages the flash in the granularity of erase block. Unfortunately, the required storage space for unified re-map table and the processor complexity will be increased dramatically when a large array of flash devices as required by a SSD drive are managed.

A flash management method is taught by Estakhri, et al. in U.S. Pat. No. 7,111,140, assigned to Lexar Media, Inc. of Fremont, Calif. Estakhri, et al. uses a controller that transfers information, organized in sectors, with each sector including a user data portion and an overhead portion, between the host and the nonvolatile memory bank and stores and reads two bytes of information relating to the same sector simultaneously within two nonvolatile memory devices. This approach is specially tailored for two bank simultaneous operation and not adequate to mange a large array of flash devices.

There a numerous of prior arts that manage the flash memory in the granularity of flash block, and lack the modular design to allow expansion of the number of flash entities. The algorithm complexity and storage required for remap tables grow dramatically with the increase of the number of flash entities. Due to the small amount of devices and thus smaller tables, these prior arts have less concern the time spending in the table search such as available cache line, the lines to evict, free block, etc. So the table searching is typically done when it is needed. However, when the table size is increased dramatically as a large array of flash is managed, the time spending in table searching will be very significant and thus reduce the system performance. These prior arts also have less concern how the replacement blocks for bad blocks are stored since remap is done in the granularity of flash block.

While these flash memory systems are useful, a more effective flash memory system is desired to improve the host performance, increase device's reliability and longevity for a system with large array of flash memories. A more efficient scheme is desired to mange the cache. A more efficient remap table is desired. A more efficient table searching method is desired. A more efficient and exact wear-leveling scheme is desired. A more efficient flash erase process is desired. A more efficient bad block management method is desired.

### DISCLOSURE OF THE INVENTION

The present invention provides a flash memory management system and method that provides the ability to efficiently manage a large array of non-volatile flash devices and allocate flash memory use in a way that improves reliability and longevity, while maintaining excellent performance level using dynamic random access memory (DRAM) as caching memory.

The flash memory management system include both hardware and software components.

The flash memory management system comprise of a processor, one or more host interfaces attached to the processor through an internal bus, a memory (typically DRAM memory) attached to processor through an internal bus, an array of flash controllers attached to processor through an internal bus, and a large array of flash memories.

The large array of flash memories organized into modules and banks. Each flash controller controls one module, and each module is comprised of a number of banks where a bank is a physical flash entity. The array of flash memories is accessed using virtual strips and virtual zones. A virtual strip comprises of a page from each bank with the same virtual strip address, where a page is defined as minimum write unit of flash memory, typically 2K bytes. The virtual strips are organized as virtual zones where each virtual zone comprises of a block from each bank with the same virtual zone address, where a block is defined as the minimum erase unit of flash memory, typically 64K bytes. It should be understood that the “flash memory” in present invention refers to any type of non-volatile memory that has similar nature to the NAND flash, such as NOR Flash, Ovonic Universal Memory (OUM), Magnetoresistive RAM (MRAM).

The mapping from virtual zone to physical zone is dynamic while the mapping from virtual strip in a virtual zone to physical strip in the corresponding physical zone is fixed.

The memory attached to processor through an internal bus is partitioned and used for storing the program executed by processor and as cache memory for flash storage data. The cache is managed by virtual strip so cache line size is the same as strip size. The cache is indexed by virtual strip block address.

The processor that executes the embedded firmware from attached memory manages the above mention large array of flash devices with caching memory through mainly with two tables, Virtual Zone Table and Physical Zone Table, a number of queues, Cache Line Queue, Evict Queue, Erase Queue, Free Block Queue, and a number of lists, Spare Block List and Bad Block List.

Virtual Zone Table (VZoneTable) is indexed by host logic block address (LBA). It stores of entries that describe the attributes of every virtual strip in this zone. The attributes include CacheIndex that is cache memory address for this strip if it can be found in cache; CacheState is to indicate if this virtual strip is in the cache; CacheDirty is to indicate which module's cache content is inconsistency with flash; and FlashDirty is to indicate which modules in flash have been written. The table also has entries to indicate if this LBA is mapped to a physical zone and what is physical zone block address (PZBA) if mapped. VZoneTable also has reserved entry for host to label the attribute of this zone to the host's interests, such as to support zoning of fiber channel and serial attached SCSI or security and access permission control.

Physical Zone Table (PZoneTable) is indexed by physical zone block address (PZBA). It stores of entries that describe the total lifetime flash write count to this block and where to find the replacement blocks in case bad blocks are found in this physical zone.

Cache Line Queue keeps tracking of available cache memory space in background and always has a cache space available whenever the firmware needs it. Evict Queue is managed by firmware in background that stores the potential cache space that can be made available for newly cached data. When the data of a physical zone is transferred to another zone and the old zone is no longer needed, it is stored in Evict Queue and the zone is erased in background by embedded processor. Free Block Queue keeps tracking of available physical zones that can be written and firmware maintains it in the background. Spare Block List is per bank based and keeps the list of blocks set aside by firmware as replacement for any bad blocks. Per bank based Bad Block List is the list of bad blocks for statistics purpose only.

Together, these tables, queues and lists provide a large array of flash memory management system that can that improves the reliability and longevity of the flash memory system, while maintaining excellent performance level using DRAM as caching memory.

### BRIEF DESCRIPTION OF THE DRAWINGS

The preferred exemplary embodiment of the present invention will hereinafter be described in conjunction with the appended drawings, where like designations denote like elements, and:

FIG. 1 is the organization of a large array of flash memories; and

FIG. 2 shows the virtual addressing derived from logic block address; and

FIG. 3 shows how the virtual zone table is constructed; and

FIG. 4 shows how the physical zone table is constructed; and

FIG. 5 is the flow chart of host access to the flash memory array; and

FIG. 6 is the flow chart of evict queue management; and

FIG. 7 is the flow chart of cache eviction and flash write management; and

FIG. 8 is the flow chart of flash free block management; and

FIG. 9 is the flow chart of flash block erase management; and

FIG. 10 is the flow chart of flash static block management for wear-leveling.

### DETAILED DESCRIPTION

The present invention provides a large array of flash memory management system and method with increased system performance, reliability and longevity.

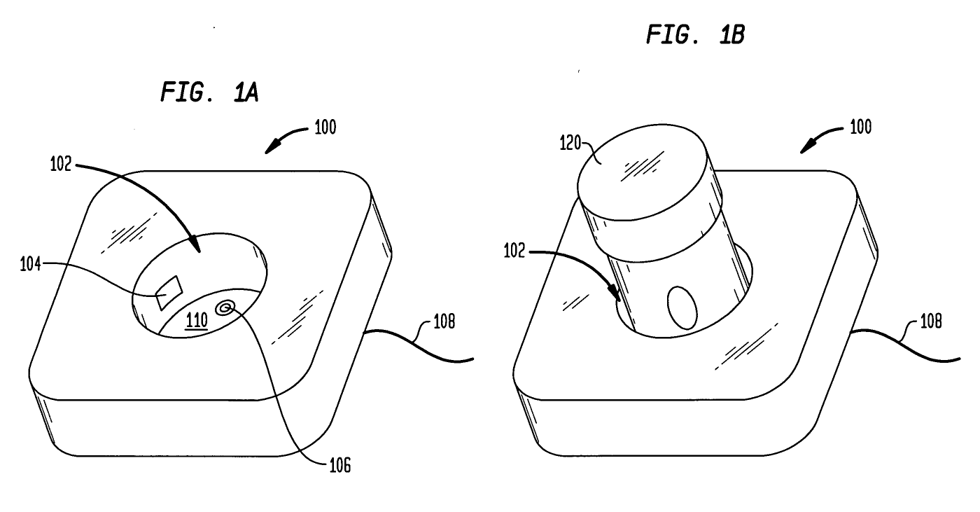

FIG. 1 shows an exemplary storage device that can best carry out the present invention.

The device utilizes a large array of flash memories. The storage device 100 is merely exemplary, and it should be understood that the invention can be implemented using different type of hardware that can include more or different features. The exemplary storage device 100 includes an embedded processor 110, a host interface 160 and a host interface controller 161, a DRAM memory 120, an internal bus 130, an array of flash module controllers 140, and an array of flash memories 150.

The embedded processor 110 performs the computation and control function of the storage device 100. The processor 110 may comprise any type of processor, including single integrated circuits such as a microprocessor, or may comprise any suitable number of integrated circuit devices and/or circuit boards working in cooperation to accomplish the function of a processing unit. In addition, processor 110 may comprise of a multiple processors. During the operation, the processor 110 executes the program from DRAM memory 120 and controls the general operation of storage device 100. In particular, the processor 110 receives the storage command from host interface 160, and decodes and serves the command. In order to fulfill the host command, the processor 110 controls how and when the data are moved between flash memory array 150 and DRAM caching memory 120 using FlashDMA engines inside module controllers 140a through 140h, and between DRAM caching memory 120 and host interface 160 using HostDMA inside Host Interface Control 161 for the best system performance while maintaining device's reliability and longevity.

DRAM/Caching memory 120 can be any type of dynamic access memory or static access memory that usually faster than flash memory. It provides the code and data storage for embedded processor 110 and also the caching for flash memory 150. The memory partition between the code and data space used for processor 110 and space used for caching is configurable by the processor 110.

Flash controllers 140 comprise of a number of module controller 140a through 140h. Each module controller with its FlashDMA controls a flash module (150a or 150b or . . . or 150h) that comprises of a number of physical flash banks.

It should be understood that concepts array, module and bank are not bounded to the physical implementation. They only refer to modular partition of multiple flash entities. The array can comprise of one or more integrated circuit (IC) packages, a module can comprise of one or more or a fractional of IC package, and a bank can comprise of one or a fractional of IC package or bare die used in multi-die package. It should also be understood that the “flash memory” in present invention refers to any type of non-volatile memory that has similar nature to the NAND flash, such as NOR Flash, Ovonic Universal Memory (OUM), Magnetoresistive RAM (MRAM).

The internal bus 130 connects all components of storage devices 100. It can be any suitable bus for high speed data transfer.

Host interface 160 and Host Interface Controller 161 are used to pass the host command to storage device 100 and move the data between host and storage device 100 using HostDMA. The interface can be any type of storage device interface such as parallel ATA, serial ATA, Fiber channel, serial attached SCSI or any proprietary interface that has processed the standard storage interface command such as parallel ATA, serial ATA, Fiber channel and serial attached SCSI. It should be understood that the host interface can comprise of one or more of above mentioned storage device interfaces that can be the same or different type.

In present invention, the array of flash memories 150 is organized into strips 170 where each strip comprises of a page from each bank with the same strip address. The page is defined as minimum write unit of flash memory, typically 2K bytes. The strips are organized as zones 180 where each zone comprises of a block from each bank with the same zone address. The block is defined as the minimum erase unit of flash memory, typically 64K bytes.

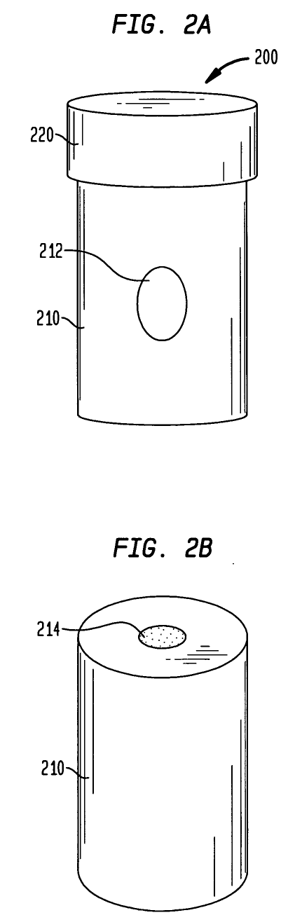

FIG. 2 shows how the flash memory array 150 is addressed in present invention.

It should be understood that the number bit of logic block address (LBA), number of modules in storage device 100, and number of banks per module are exemplary. The implementation of present invention may be different in number of bits in LBA, number of modules and number of banks per module from those shown in 200. The logic block address (LBA) 210 received from host interface 160 is in the unit of 512 bytes. The strips 170 are addressed using virtual strip block address (VSBA) 220 which is in the unit of 128 Kbytes in this example. A virtual zone 180 is addressed using virtual zone block address (VZBA) 230 that is in the unit of 4 Mbytes in this example.

To address the physical array of flash, the virtual address needs to be mapped to physical address. This comprises the mapping from virtual zone address to physical zone address 230, from virtual strip address to physical strip address in the same zone 240, and from virtual module/bank to physical module/bank 250.

The mapping from virtual zone address to physical zone address 230 is implemented in Virtual Zone Table 300. The wear-leveling of flash memory is achieved through this mapping. The mapping of strip address in the same zone 240 is unaltered so there is one to one fixed correspondence. The mapping of virtual module/bank to physical module/bank 250 is controlled by processor 110. Two example mappings are

(1) LBA[4:2] for bank selection, LBA[7:5] for module selection,
(2) LBA[4:2] for module selection, LBA[7:5] for bank selection.
It should be understood that the processor 110 can figure any possible mapping.

Physical zone block address PZBA is formatted such that upper 8 bits PZBA[31:24] indicate the physical bank/module location and lower 24 bits PZBA[23:0] indicate the zone address in the bank.

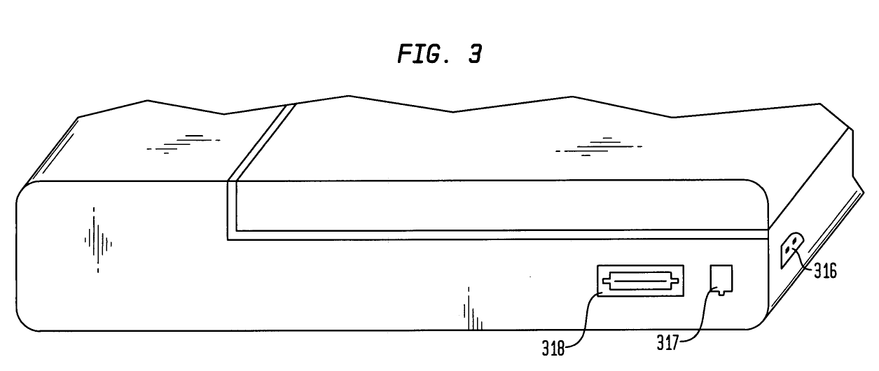

FIG. 3 shows the organization of Virtual Zone Table 300.

The table is indexed by virtual zone block address VZBA 310. Each virtual zone 300a, 300b or 300n has the entries
VZoneState It takes one of 6 possible states: InFlash, LineFilling, InCache, InEvictQueue, Evicting, Swapping. They are used to indicate the current state of virtual zone. State InFlash means that the current virtual zone is not in cache.
   State LineFilling means part or all of current virtual zone is being loaded to cache.
   State InCache means that part or all of current virtual zone can be found in cache,
   State InEvictQueue means the current virtual is in evict queue and selected as candidate to be de-allocated from cache.
   State Evicting means the current virtual zone is being written back to flash.
   State Swapping means that the virtual zone is being swapped with other zones.
PZBAMapped It indicates if current virtual zone has been mapped to a physical zone. It takes either value 1 or 0.
HostAttributes This is for host to label host's specific attributes such as supporting of zoning of fiber channel and serial attached SCSI or security and access permission control.
PZBA Mapped PZBA address if PZBAMapped is true
   For each strip of this zone,
CacheIndex That is the cache memory address in double word (32 bit) for this strip, if it can be found in cache. Note, strips in a virtual zone don't have to be in contiguous cache memory space.
CacheState This is state of each virtual strip in this virtual zone.
   State Invalid means the strip is not in cache.
   State Line-filling means the strip is being loaded to cache.
   State Valid means the strip is in cache.
   State Line-evicting means the strip is being written back to flash.
CacheDirty Cache content is modified and inconsistent with flash content. 1 bit per module, i.e., the granularity of flash write is module. Note, this is to save dirty bits. If we want control write at bank granularity, we would need 64 dirty bits per strip.
FlashDirty Indicates the Flash module has been written. Ibit per module, i.e., the granularity of flash write is module. Note, this is to save dirty bits. If we want control write at bank granularity, we would need 64 dirty bits per strip.
   Initial state:
   VZoneState is InFlash
   PZBAMapped is false
   CacheState is invalid for all strips
   CacheDirty and FlashDirty are false for all strips

Each virtual zone requires 32×2+2=66 double words storage space. Assuming 256 Gbytes total flash array and 4 Gbytes per bank, the total number of virtual zones=256 G/4M=64K, and the VZoneTable size=64K*66=4.224 M double words=16.9 Mbytes.

If bank granularity is used for flash write, this VZoneTable size would be 2.5×16.9=42.24 MBytes. It should be noted that present invention doesn't limit to use a module (8 banks) as granularity for flash write. Any number of banks can be used as basic granularity for flash write. A module granularity is chosen primarily to save storage space required for VZoneTable and due to the diminishing system performance return by using a small granularity.

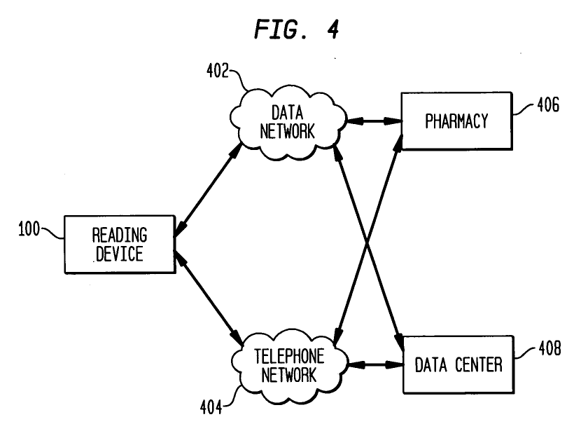

FIG. 4 shows the organization of Physical Zone Table 400.

The table is indexed by physical zone block address PZBA 410. Each physical zone 400a, 400b or 400n has the entries
PZoneState It takes one of 4 possible states Erased, Ready, Written, Stale:
   State Erased means the physical zone is erased and clean.
   State Ready means an erased physical zone has been selected in FreeBlockQueue ready to be written.
   State Written means that physical zone has been written State Stale means the flash content has been copied out and the physical zone can be erased.
ReplacementBlockIndex If 0, no bad block in this physical zone. A non-zero value is a system memory address where 16 double words are allocated to store the replacement physical blocks. 15 of 16 double words are used to store replacement blocks. The last entry is used to create a link list in case more than 15 physical blocks are bad in this zone. Note, there are 8 modules×8 banks=64 physical blocks in each physical zone.
TotalWriteCount: Total flash write count to this physical zone used in wear-leveling process to indicate the lifespan of this zone.

### Initial: PZoneState=Erased

ReplacementBlockIndex=build from media
TotalWriteCount=0

Assuming the same storage capacity as VZoneTable, the PZoneTable size is 64K*3=192K double words=768 Kbytes

It should be understood that it is possible to merge VZoneTable and PZoneTable into one table indexed by virtual zone address. However, ReplacementBlockIndex and TotalWriteCount are needed to move to new virtual zone whenever a physical zone is mapped to a different virtual zone.

As discussed earlier, each physical zone has 64 physical blocks. And most of blocks of the array are supposed to be defect-free in order for the storage device to be useful. So we only allocate 1 double word for each physical zone so this location can be used as a link list for replacement blocks.

Virtual Zone Table and Physical Zone Table, plus a number of queues, Cache Line Queue, Evict Queue, Erase Queue, Free Block Queue and Spare Block List and Bad Block List are the means for embedded processor 110 to manage the large array of flash memories.

### CacheLineQueue:

Entries: cache index or system memory address
Initial: All DRAM space allocated for cache.

Firmware manages a queue for all un-allocated cache lines. When a line is allocated, it is removed from the queue and entered somewhere in VZoneTable as cache index and CacheState is set to valid. When a line is evicted from cache to flash, the used cache line is returned to tail of this queue. The CacheState is set to invalid in VZoneTable.

This dramatically saves the real time spending in searching cache lines that can be allocated and improves system performance.

### EvictQueue

Entries: VZBA address
Initial: empty

Firmware maintains a small evict queue in background. The LBA is random generated. It is checked against VZoneTable and make sure it is in the cache. Some other conditions may be added. If generated LBA meets these conditions, it is pushed to EvictQueue. The purpose of this queue is that when the cache utilization is above a threshold, a cache line can be readily available from this queue to be written back to flash.

This dramatically saves the real time spending in searching victim cache lines and improves system performance.

### EraseQueue

Entries: PZBA address
Initial: empty

Firmware maintains a small erase queue in background. When a cache line is de-allocated from cache and the cache line is mapped to PZBA in VZoneTable, the PZBA is pushed to EraseQueue and its PZoneState is changed to Stale. Once it is erased without error, the PZoneState is changed to Erased.

This queue allows the erase process is done in background when system finds the idle time. The system performance will not be impacted by flash erasure.

### FreeBlockQueue

Entries: PZBA address

### Initial: Empty

Firmware maintains a small queue of physical zones that can be readily used to write. The selection meets certain criteria for wear-leveling. This is a background task.

A write threshold count WearThreshold is initially set by software. If the FreeBlockQueue is not full, the next PZBA is evaluated against PZoneTable. If the PZoneState is state Erased and the TotalWriteCount is less than the WearThreshold, the PZBA is pushed to FreeBlockQueue and the PZoneState is changed to Ready.

Again, this is very similar to EvictQueue and done in background. It dramatically saves the real time spending in searching the destination zone to write that meets the wear-leveling criteria and thus improves system performance.

### SpareBlockQueue0→SpareBlockQueue63

Entries: PBA address
Initial: set aside blocks by firmware as bad block replacement

These are blocks set aside by firmware as replacement for any bad blocks. The list is per bank based.

### BadBlockList0→BadBlockList63

Entries: PBA address
Initial: bad blocks built from manufacture shipped parts

These are the list of bad blocks for statistics purpose only and are per bank based.

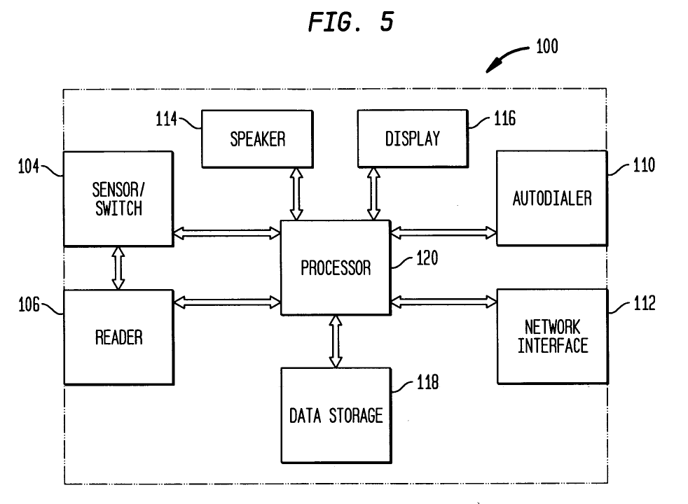

All queues are maintained in background by embedded processor 110 so it doesn't use critical cycles and thus the system performance is optimized. FIG. 5 through 10 shows how these tables and queues can be used to manage the large array of flash memories and the system performance advantage is evident.

FIG. 5 shows the flow chart of host access to the flash memory array.

Host access starts with idle state 501. Host issued logical block address LBA is used to index VZoneTable in 502. CacheState of current strip is checked to see if it is valid in 503. If the strip is in cache, host DMA is setup to transfer data between host and cache in 504 and CacheDirty flags are set properly for write. If the strip is not in cache, a cache line is allocated from CacheLineQueue in 505 and VZoneTable is further checked in 506 to see any flash data need to be DMAed into cache before host can access the cache. Under the conditions (1) Physical zone has been mapped to this virtual zone (2) one or more flash module have been written (3) the write doesn't cover entire strip, PZoneTable is indexed using mapped PZBA and proper DMA is setup to read flash into cache in 507. Note, the granularity for ant flash read/write is a module. Upon the completion of DMA, if it is found no uncorrectable read error 509, host DMA is setup in 512 to complete host command. In case an uncorrectable read error, same flash content is read again 510. Regardless if there is an uncorrectable read error at second read 511, host command is completed 512. Uncorrectable read error status can be set in 513 before host command is completed so host is aware of this error and may take proper action. In case there is no need to read from flash such as the entire strip will be written, host DMA is setup immediately in 508 and host command is completed with proper CacheState, CacheDirty update in VZoneTable in 508.

It should be understood that is flow chart 500 is assumed that the host requested data transfer size is confined within one cache line for the clarity of explanation. A more sophisticated flow chart can be drawn to remove this limitation.

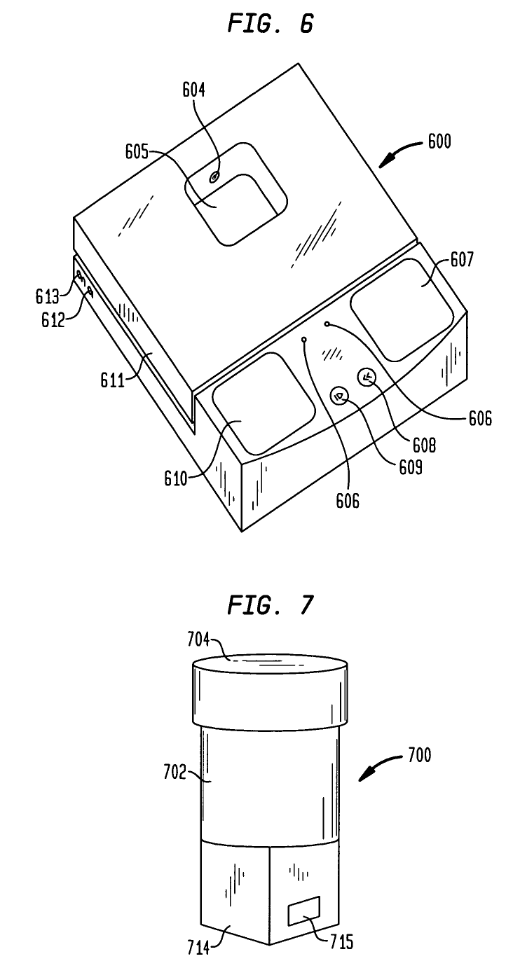

FIG. 6 shows how embedded processor 110 maintain the evict queue as a background task 600.

The task starts with the idle state 601. There is nothing needs to be done if EvictQueue is full 602. If EvictQueue is not full, a LBA is randomly generated in 603. The generated LBA is checked against VZoneTable and make sure one or more strips of this zone are in the cache 604. Some other conditions may be added 604 to further qualify the generated zone as an eviction candidate. If generated LBA meets these conditions, it is pushed to EvictQueue 605. The purpose of this queue is that when the cache utilization is above a threshold, a cache line can be readily available from this queue to be written back to flash to avoid cache thrash. This dramatically saves the real time spending in searching victim cache lines and improves overall system performance.

FIG. 7 shows the flow chart 700 how a cache line is de-allocated from cache and written back to flash memory.

The flow chart 700 starts with idle state 701. Whenever a cache line is allocated in 505, UsedCacheLines is incremented by 1 in 702. If UsedCacheLines is greater than a threshold 703, i.e., when cache utilization is considered high, a cache line will be de-allocated from cache from step 704. The virtual zone to be written back to flash is retrieved from EvictQueue and its CacheIndex and CacheDirty status are retrieved from VZoneTable in 704.

As required by wear-leveling, when a virtual zone is evicted back to flash, it is preferred to be written to a clean erased zone. However, the current flow chart 700 disclosed the possibility to write back to the same zone when certain condition meets. Same zone write saves an erase cycle and some flash bank read/write cycles. This condition is captured in 705. It indicates that the data being written to flash is targeted to clean modules and the zone is under wear-leveling threshold.

If it is decided the flash write will be targeted to the same zone, physical zone information is retrieved from PZoneTable in 706. DMA is setup to write back those dirty lines in this zone back to flash in 707.

If it is decided the flash write will be targeted to a new zone in 705, the new physical zone address is retrieved from FreeBlockQueue and all physical information are retrieved from PZoneTable in 712. Those flash strips are FlashDirty but not in Cache need to be DMAed in the cache as in 713. If there is no uncorrectable read error 714, the zone will be DMAed in to flash 707. If there is uncorrectable read error 714, the flash is read again 715. Regardless if there is uncorrectable read error, the zone will be DMAed in to flash 707.

If there is write error detected in 708, a replacement block in the same bank is used to replace the defect one 716, and write will be repeated in 707. If there is no write error is detected in 708, all cache lines from evicted zone are returned to CacheLineQueue and cache states are properly updated in VZoneTable in 709. PZoneTable is properly updated and TotalWriteCount is incremented by 1 in 710. The released zone is pushed to EraseQueue to be erased 710. UsedCacheLines is decremented by 1 in 711 and the process completes.

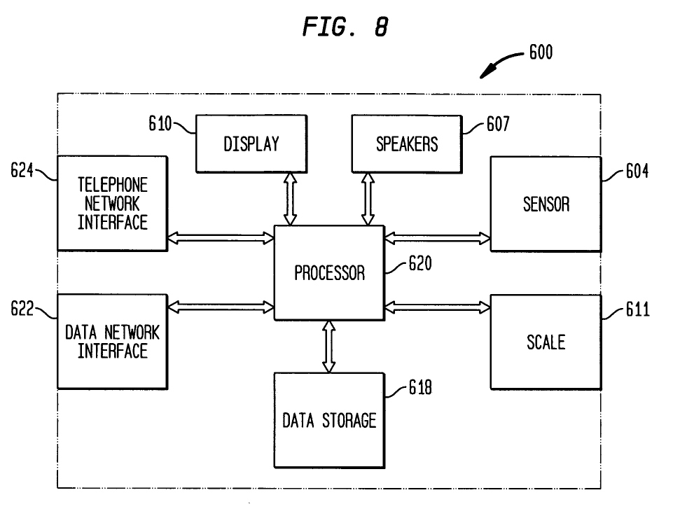

FIG. 8 shows how physical zone are managed and selected for write.

The flow chart 800 starts with idle state 801. The flow continues only if FreeBlockQueue is not full 802 and the next physical zone is examined for its PZoneState in 803. If it is a clean zone 804, the TotalWriteCount to this zone is checked against a Wear-Leveling threshold in 805. If the zone is less wear comparing to the threshold in 805, it is pushed into FreeBlockQueue 806 and the zone becomes a candidate for flash write. If the zone has more wear than the threshold, the processor can evaluate to increase the threshold or warn the host that the storage device is close to end of life 807, based on the statistics the processor is tracking.

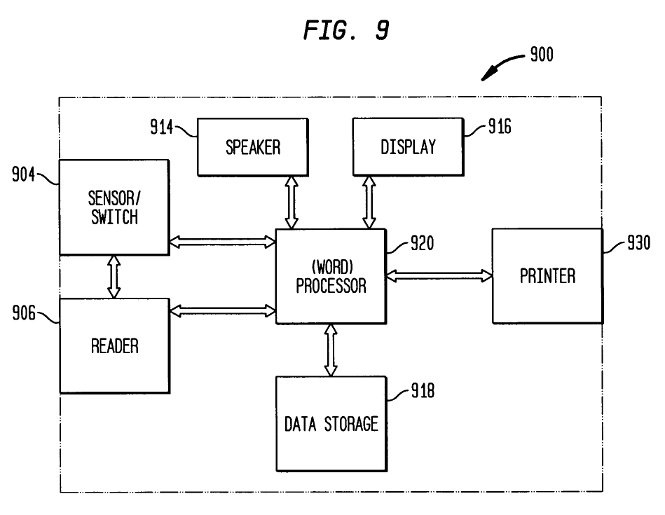

FIG. 9 shows the flash block erase flow.

The flow chart 900 starts with idle state 901. If EraseQueue is not empty as determined in 902, the embedded processor gets a physical zone address from EraseQueue and setups the erase process 903. When erase is completed without erase error from any bank 905, the PZoneState is set to Erased and this completes the erase of this zone. If one or more bank has erase error in 905, one or more replacement blocks are obtained from SpareBlockList to replace the defect one, ReplacementBlockIndex and BadBlockList are updated accordingly. Note, replacements are assumed to be erased already.

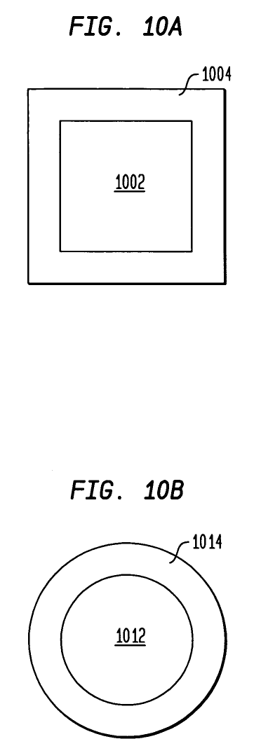

FIG. 10 show how a static zone is identified and participated in wear-leveling process.

The wear-leveling is mainly implemented through the dynamic mapping from virtual zones to physical zones, where a new physical zone (erased clean one) is obtained for each write so the write will spread cross all available physical zones. However, the way the new zone is selected limits those static blocks, i.e., the blocks rarely change once they are written, from the wear-leveling. To cure for this, an algorithm is implemented in the background so static zone can be identified and its content can be swapped to another zone so the static zone is made available for write. FIG. 10 shows this flow. Basically all physical zones are linearly checked to see if it is a static zone.

The flow chart 1000 starts with idle state 1001. The zone pointer is incremented by 1 and VZoneTable and PZoneTable are retrieved in 1002. If the zone is not in cache, some physical banks are dirty, and TotalWriteCount is below the software programmable StaticThreshold that is programmed much smaller than WearThreshold, the zone is considered static 1003. Once a static zone is identified, a new physical zone is obtained from FreeBlockQueue and its physical information is retrieved from PZoneTable in 1004. The DMA is set to read out all dirty banks to a fixed dram location in 1005. And the data is transfer to newly obtained physical zone in 1006. VZoneTable and PZoneTable are properly updated in 1007. It should be noted that a cache line can be allocated for this zone swapping. However, a fixed location can also be used, which is easier to implement.

The present invention provides a large array of flash memory management system and method with improved system performance. The embodiments and examples set forth herein were presented in order to best explain the present invention and its particular application and to thereby enable those skilled in the art to make and use the invention. However, those skilled in the art will recognize that the foregoing description and examples have been presented for the purpose of illustration and example only. The description as set forth is not intended to be exhaustive or limit the invention to the precise from disclosed. Many modifications and variations are possible in light of the above teaching without departing from the spirit if the forthcoming claims.

What is claimed is:

1. An apparatus comprising:
a) a processor
b) a host interface attached to the processor through an internal bus
c) a memory attached to processor through an internal bus
d) an array of flash controllers attached to processor through an internal bus
e) a large array of flash memories organized into modules and banks. Each flash controller controls one module, and each module is comprised of a number of banks where a bank is a physical flash entity. The array of flash memories is accessed using virtual strips and virtual zones. A virtual strip comprises of a page from each bank with the same virtual strip address, and the page is defined as minimum write unit of flash memory, typically 2K bytes. The virtual strips are organized as virtual zones where each virtual zone comprises of a block from each bank with the same virtual zone address, and the block is defined as the minimum erase unit of flash memory, typically 64K bytes. Each virtual zone is mapped to physical zone.

2. The apparatus of claim 1 wherein the virtual module and virtual bank are configurable through software, and the virtual module and virtual bank don't have to align with physical module and physical bank.

3. The apparatus of claim 1 wherein the flash management system is scalable with the number of modules and the number of banks in the flash array. The array, module and bank are not bounded to any physical implementation. They only refer to the modular partition of multiple flash entities. The array can comprise of one or more integrated circuit (IC) packages, a module can comprise of one or more or a fractional of IC package, and a bank can comprise of one or a fractional of IC package or bare die used in multi-die package. The “flash memory” in present invention refers to any type of non-volatile memory that has similar nature to the NAND flash, such as NOR Flash, Ovonic Universal Memory (OUM), Magnetoresistive RAM (MRAM).

4. The apparatus of claim 1 wherein the array of flash memory is addressed by host by logical block address. The logical block address is further translated into virtual zone address and virtual strip address. The virtual zone address is mapped to a physical zone address through a table VZoneTable to obtain physical zone and then physical strip address. The physical zone/strip address is further mapped to the physical block address if there is defect block in this zone through a table PZoneTable for physical flash access.

5. The apparatus of claim 1 wherein the memory attached to processor through an internal bus is partitioned and used for storing the program executed by processor and as cache memory for flash storage data, wherein the cache line is managed by virtual strip so cache line size is the same as strip size. The cache is indexed by virtual strip block address. The cache eviction and flash write and erase is managed by virtual zone. The virtual strips in a single virtual zone don't have to be in contiguous space in cache memory.

6. A method of flash memory management system residing in the memory and being executed by the processor, the flash memory management system including:
a) a virtual zone table for managing the virtual flash space
b) a physical zone table for managing the physical flash space
c) a cache line queue for storing the available cache lines to be allocated
d) a evict queue for storing the cache lines that can be de-allocated
e) a erase queue for storing the physical zones that are ready to be erased
f) a free block queue for storing the physical zones that can be written
g) a spare block list for storing the physical blocks that are set aside as replacement for defect blocks. The list is per bank based.
h) a bad block list for storing the bad blocks for statistics purpose only. The list is per bank based.

7. The apparatus of claim 6 wherein the virtual zone table VZoneTable is indexed by virtual zone block address. Each virtual zone has the entries
VZoneState Used to indicate the current state of virtual zone.
PZBAMapped Indicates if current virtual zone has been mapped to a physical zone.
PZBA Mapped physical zone block address if PZBAMapped is true.
HostAttributes For host to label host's specific attributes.
For each strip in this zone, it has the entries
CacheIndex Cache memory address in double word for this strip if it is in cache.
CacheState Used to indicate the current state of virtual strip.
CacheDirty Cache content is modified and inconsistent with flash content. Ibit per module, i.e., the granularity of flash write is module.
FlashDirty Indicates the Flash module has been written. Ibit per module, i.e., the granularity of flash write is module.

8. The apparatus of claim 6 wherein the physical zone table PZoneTable is indexed by physical zone block address. Each physical zone has the entries
PZoneState Indicate the state of current physical zone.
ReplacementBlockIndex Used to locate the replacement zone for defect one if there is any.
TotalWriteCount: Total write count to this physical zone used in wear-leveling process.

9. The apparatus of claim 6 wherein the cache line queue CacheLineQueue for all un-allocated cache lines. It has the entry as CacheIndex. When a line is allocated, it is removed from the queue and entered somewhere in VZoneTable as cache index. When a line is evicted from cache to flash, the used cache line is returned to tail of this queue. This dramatically saves the real time spending in searching cache lines that can be allocated and improves system performance.

10. The apparatus of claim 6 wherein the evict queue EvictQueue for a cache line that can be de-allocated from cache. It has the entry virtual zone block address. Firmware maintains this queue in background. The LBA is random generated. It is checked against VZoneTable and make sure it is in the cache. Some other conditions may be added. If generated LBA meets these conditions, it is pushed to EvictQueue. The purpose of this queue is that when the cache utilization is above a threshold, a cache line can be readily available from this queue to be written back to flash. This dramatically saves the real time spending in searching victim cache lines and improves system performance.

11. The apparatus of claim 6 wherein the erase queue EraseQueue for zones to be erased. It has the entry physical zone address. Firmware maintains this queue in background. When a cache line is de-allocated from cache to a new physical zone, the old physical zone is released and pushed to EraseQueue. Firmware erases zones in this queue in background. When a zone is erased, it can be reused again. This queue allows the erase process is done in background when system finds the idle time. The system performance will not be impacted by flash erasure.

12. The apparatus of claim 6 wherein the free block queue FreeBlockQueue for physical zones that can is erased and readily available to write a cache line to it. It has the entry physical zone address. Firmware linearly searches through entire physical zones in background. If a zone is erased and its TotalWriteCount is less than a software defined threshold, the zone is pushed to FreeBlockQueue. It dramatically saves the real time spending in searching the destination block to write that meets the wear-leveling criteria and thus improves system performance when a cache line needs to be de-allocated from cache.

13. The apparatus of claim 6 wherein the spare block list SpareBlockList for the blocks set aside by firmware as replacement blocks for any bad blocks. It has the entry physical block address. The list is per bank based. And the bad block list BadBlockList for bad blocks for statistics purpose only. It has the entry physical block address. The list is per bank based.

14. A method of managing the host access using the flash memory management system of claim 6. The method uses the cache as local storage to exchange data with host and cache is managed by virtual strip. The cache is allocated for both host read miss and write misses. The cache line de-allocation uses a random algorithm to pre-select the candidates that can be de-allocated from cache in EvictQueue.

15. A method of managing the de-allocated cache line using the flash memory management system of claim 14. The method uses a pre-selected physical zone stored in FreeBlockQueue that can be used to write back the de-allocated cache line.

16. A method of managing the de-allocated cache line using the flash memory management system of claim 14. The method allows the flash write back to the same physical zone or different physical zone by checking the CacheDirty/FlashDirty and other entries in VZoneTable. The de-allocation is based on cache utilization, i.e., the used cache memory vs. the total available cache memory.

17. A method of managing the flash erase using the flash memory management system of claim 14. The method uses an erase queue in claim 11 and the erase process is achieved in background by processor when processor finds the idle time.

18. A method of managing the flash wear-leveling using the flash memory management system of claim 14. The method uses the dynamic mapping of virtual zone to physical zone of claim 1 so a new physical zone (erased clean one) is obtained for each write so the write will evenly spread over all available physical zones.

19. A method of static block wear-leveling using the flash memory management system of claim 14. The method identifies the static zone in background by searching through entire physical zone by comparing its TotalWriteCount and a software programmed threshold. Once a static zone is identified, its content can be swapped with another zone so the static zone is made available for write.

20. A method of managing the flash bad blocks using the flash memory management system of claim 14. The method uses PZoneTable as start point to indicate if there is any bad block in this zone. If there is any bad block in this zone, a link list method is provided to list out all replacement blocks.
